(19) United States
(12) Patent Application Publication
(10) Pub. No.: US 2025/0100708 A1
(43) Pub. Date: Mar. 27, 2025

(54) HELICOPTER

(71) Applicant: Tusas- Turk Havacilik Ve Uzay Sanayii Anonim Sirketi, Kahramankazan, Ankara (TR)

(72) Inventor: Murat BACANAK, Kahramankazan, Ankara (TR)

(73) Assignee: Tusas- Turk Havacilik Ve Uzay Sanayii Anonim Sirketi, Kahramankazan, Ankara (TR)

(21) Appl. No.: 18/725,192

(22) PCT Filed: Nov. 10, 2022
(86) PCT No.: PCT/TR2022/051278

§ 371 Date: Jun. 28, 2024

(30) Foreign Application Priority Data
Dec. 29, 2021 (TR) 2021/021505

(51) Int. Cl. B64D 43/00; B64C 27/04

(52) U.S. Cl. CPC B64D 43/00; B64C 27/04

(57) ABSTRACT

The present invention relates to a body (2); a cut out (3) located on the body (2); a sensor (4) located in the cut out (3) so as to move outwards from the body (2), and enabling the data requested by the user to be obtained; at least one control unit (5) that controls operation of the sensor (4); a first position (I) in which the sensor (4) is substantially located in the cut out (3); a second position (II) to which the sensor (4) is brought by moving, and in which the sensor (4) extends through the cut out (3) outward from the body (2).

The present invention relates to a helicopter comprising movable sensors on its body.

Sensors are provided in various positions on the helicopter body. These sensors are used to obtain data on different subjects such as obtaining flight data, detecting external threats, etc. Sensors are usually located on an outer surface of helicopters. Placement of the sensors can be performed based on factors such as sensor shading, structural factors, temperature, etc. In a sufficient area suitable for placement, the sensors are mounted on the helicopter body. In flight, the sensors located on the outer surface of the helicopter cause aerodynamic drag.

The U.S. Pat. No. 5,918,834A, which is included in the known-state of the art, discloses an air vehicle sensor system and a retractable sensor system for the air vehicle. The sensor moves from a retracted position to an extended position. Reinforced elastomer sections on the plane's die line surface cover the sensor and actuation mechanism. The reinforced elastomer section has an inner surface and an outer surface. The sensor is located adjacent to the inner surface. The reinforced elastomer section has a flat position and an extended position.

Thanks to a helicopter according to the present invention, sensors located on an outer surface of the helicopter are enabled to be sealed.

An object of the invention is to prevent the sensors located on the outer surface of the helicopter from being damaged by external factors such as dust, sand, or rain water.

Another object of the present invention is to enable mission sensors located on the outer surface of the helicopter to receive data both in inner and outer areas of the helicopter body.

A further object of the present invention is to enable the sensors located on the outer surface of the helicopter to be received into the body when not in use, thereby reducing aerodynamic drag.

The helicopter realized to achieve the object of the invention, which is defined in the first claim and other claims dependent thereon, comprises a body; a cut out located on the body. A sensor is located on the body to be movable outwards from the cut out, the sensor enabling the data requested by a user to be received. There is a control unit that controls operation of the sensor. The helicopter comprises a first position (I) in which the sensor is located in the cut out; and a second position (II) in which the sensor extends outward from the body, wherein the sensor is moved outwards through the cut out to be brought to the second position (II).

The helicopter according to the invention comprises a sensor surface that allows the sensor to receive data. The sensor surface is a part of the sensor that faces out of the body and is located outside the body in contact with the aerodynamic air. There are multiple lateral walls extending from the sensor surface into the body. The lateral walls extend from front surface walls into the body. A sheath made of a flexible material is provided, which seals the lateral walls in the first position (I) and the second position (II). One side of the sheath is connected to the wall of the cut out, and the other side thereof is connected to the lateral walls. The sheath completely surrounds the lateral walls and can be folded as the sensor moves from the second position (II) to the first position (I). In this way, the sensor is protected by the sheath from environmental factors such as dust, sand or water. When the sensor is in the second position (II), the risk of water entering the helicopter through the cut out area is also avoided. In cases where the sheath is torn, deformed or damaged due to aerodynamic effects, the lateral walls support and protect the sensor.

In an embodiment of the invention, the helicopter comprises the sheath with one end connected to an inner surface of the cut out, and the other end connected to an area between the front surface and the lateral walls. As the sensor moves from the second position (II) to the first position (I), the sheath is folded and/or compressed and received into the cut out. The sheath remains in the cut out in a folded state, thus protecting the sensor from external factors.

In an embodiment of the invention, the helicopter comprises the front surface which is substantially aligned with the wall of the cut out when the sensor is in the first position (I). The front surface is located nearly identical to the wall of the cut out. Therefore, when the sensor is in the first position (I), it is substantially located in the cut out, and the front surface is also aligned with the body surface so as to match with the body surface without gaps.

In an embodiment of the invention, the helicopter comprises the sheath which is compressed such that there is no gap between the walls of the cut out and the sensor when the sensor is in the first position (I). The sheath allows the sensor to be kept still in the cut out, thus preventing aerodynamic effects and absorbing vibrations.

In an embodiment of the invention, the helicopter comprises the front surface which allows the sensor to obtain data in both the first position (I) and the second position (II); and the control unit which controls the data received from the sensor. The front surface is exposed so as to be in direct interaction with the aerodynamic surface, and is not covered with a sheath. The sheath is attached to the lateral walls. In a first position (I), in which the front surface and outer surface of the helicopter body are aligned, the lateral walls are located fully in the cut out in correspondence with the wall of the cut out. In conditions where damage to the lateral walls is possible or when data is required to be obtained quickly, in the first position (I) where the sensor is located in the body, the desired information can be received by the front surface. The control unit controls the data received by the sensor at both positions.

In an embodiment of the invention, the helicopter comprises a support element located partially around the lateral walls, attached to the sensor, and surrounded by the sheath; at least one rail in the cut out, which allows the sensor to slide thereon. There is an actuator, which is preferably in mechanical connection with the support element and can slide on the rail to move into or out of the linear body. The control unit triggers the actuator with the command received by a pilot. When the actuator is activated, the sensor mechanically connected to the support element is brought from the first position (I) to the second position (II) or from the second position (II) to the first position (I).

In an embodiment of the invention, the helicopter comprises a stopper on the rail, which stops and fixes the actuator in alignment with the wall of the cut out in a position predetermined by the user, as the sensor moves from the first position (I) to the second position (II) or from the second position (II) to the first position (I). When the sensor is in the cut out in the first position (I) or when the sensor is moved out of the cut out in the second position, the stopper enables the sensor to stop at end limit positions.

In an embodiment of the invention, the helicopter comprises the actuator, which is any of the hydraulic, pneumatic, or electric motor types.

In an embodiment of the invention, the helicopter comprises the sheath made of a water-resistant leather material. The sheath is preferably made of a flame resistant (Flame Resistant Leather, Cassini 1789, Black) or water-resistant leather material.

In an embodiment of the invention, the helicopter comprises the sensor such as a laser warning system, a missile warning system, an RWR spiral antenna, which is located on the outer surface of the helicopter and allows the data requested by the user to be received.

In an embodiment of the invention, the helicopter comprises the support element produced by an NC production method. The support element is preferably made of an aluminum alloy material. The strong support element provides rigidity to the sensor and protects the sensor in case of possible damage and deformation of the sheath. Further, the support element connected to the sensor by means of mechanical fasteners is triggered by the actuator to move the sensor.

The helicopter realized to achieve the object of the present invention is illustrated in the attached drawings, in which:

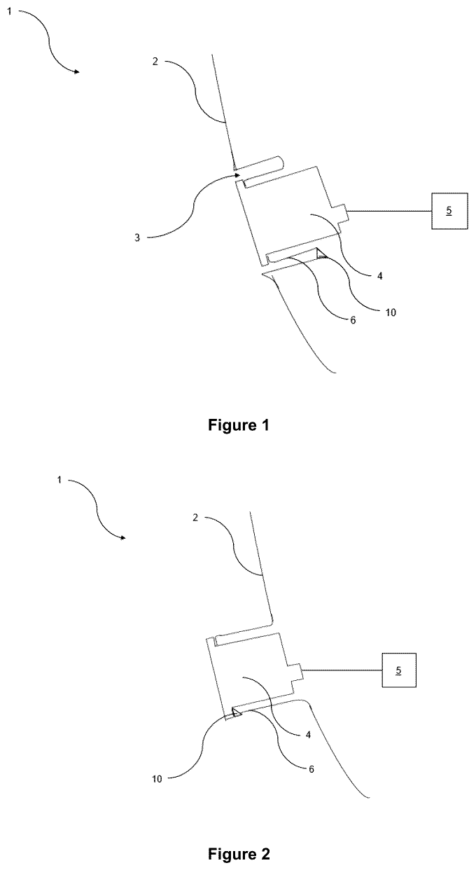

FIG. 1 is a schematic view of the sensor and the sheath in the first position (I).

FIG. 2 is a schematic view of the sensor and sheath in the second position (II).

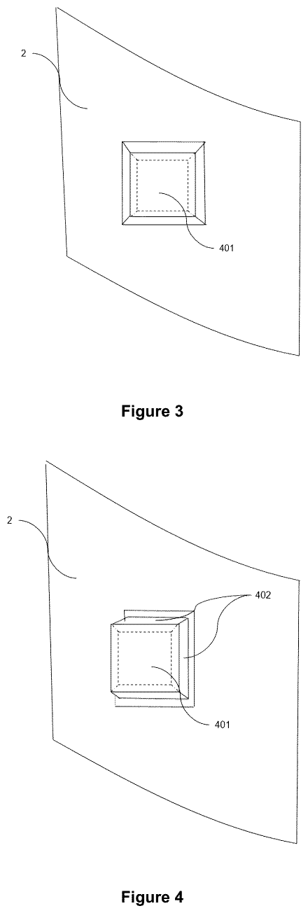

FIG. 3 is a schematic view of the sensor in the first position (I).

FIG. 4 is a schematic view of the sensor in the second position (II).

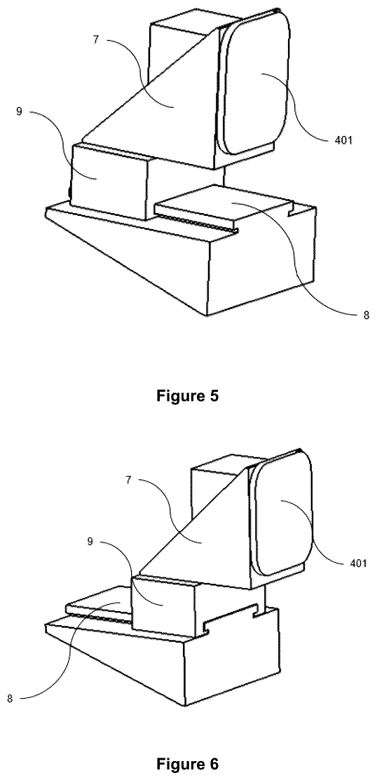

FIG. 5 is a perspective view of the sensor, support element, rail, actuator in the first position (I).

FIG. 6 is a perspective view of the sensor, support element, rail, actuator in the second position (II).

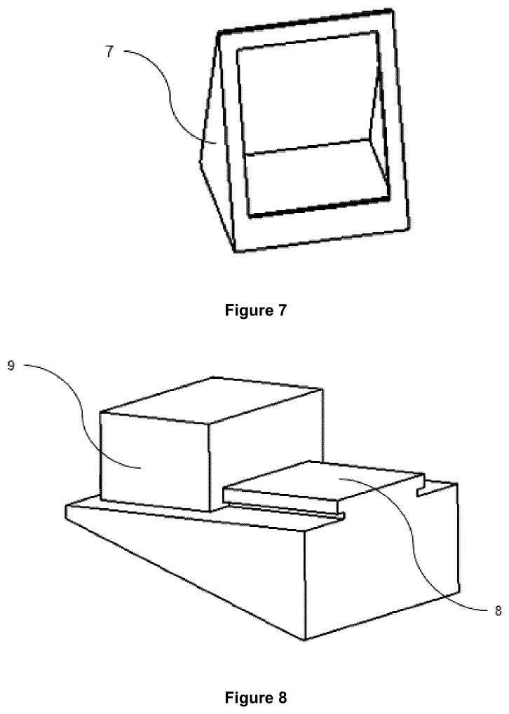

FIG. 7 is a perspective view of the support element.

FIG. 8 is a perspective view of the rail and the actuator.

All the parts illustrated in figures are individually assigned a reference numeral and the corresponding terms of these numbers are listed below:
1. Helicopter
2. Body
3. Cut out
4. Sensor
   401. Front surface
   402. Lateral walls
5. Control unit
6. Sheath
7. Support element
8. Rail
9. Actuator
10. Stopper
   (I). First position
   (II). Second position

The helicopter (1) comprises a body (2); a cut out (3) located on the body (2); a sensor (4) located in the cut out (3) so as to move outwards from the body (2), and enabling the data requested by the user to be obtained; at least one control unit (5) that controls operation of the sensor (4); a first position (I) in which the sensor (4) is substantially located in the cut out (3); a second position (II) to which the sensor (4) is brought by moving, and in which the sensor (4) extends through the cut out (3) outward from the body (2).

The helicopter (1) according to the invention comprises a front surface (401) which is a part of the sensor (4) facing outward from the body (2), and which allows the sensor (4) to receive data; at least one lateral wall (402) located on the sensor (4), extending from the front surface (401) into the body (2), and allowing the front surface (401) to be held; a sheath (6) made of a flexible material, with one side thereof connected to the wall of the cut out (3) and the other side to the sensor (4) so as to completely surround the lateral walls (402), wherein the sheath (6) can be folded as the sensor (4) moves from the second position (II) to the first position (I), wherein the sheath (6) provides sealing between the sensor (4) and the cut out in the first position (I) and the second position (II).

There are cut outs (3) on the body (2) of the helicopter (1) at certain places. Sensors (4) are provided in the cut out (3), which enable the data requested by the user to be received according to the purpose of use. The sensors (4) are located in the cut out (3) so as to move out of the cut out (3). There is a control unit (5) that controls operation of the sensor (4). There is a first position (I) in which the sensor (4) is located in the cut out (3); and a second position (II) to which the sensor (4) is brought by moving outwardly through the cut out (3), and in which the sensor (4) extends outward from the body (2).

The sensor (4) has a front surface (401) for receiving the desired data. There is a plurality of lateral walls (402) extending from the front surface (401), which is the surface of the sensor (4) facing outward from the body (2), to the inside of the body (2). There is a sheath (6) made of a flexible material, which seals the lateral walls (402) in the first position (I) and the second position (II). One side of the sheath (6) is connected to the wall of the cut out (3) and the other side is connected to the lateral walls (402). The sheath (6) completely surrounds the lateral walls (402). The sheath (6) can be folded as the sensor (4) moves from the second position (II) to the first position (I). Therefore, the sensor is protected by the sheath (6) from environmental factors such as dust, sand or water. When the sensor (4) is in the second position (II), the risk of water entering the body (2) through the cut out (3) region is also prevented.

In an embodiment of the invention, the helicopter (1) comprises the sheath (6) with one end connected to the inner wall of the cut out (3), and the other end connected between the front surface (401) and the lateral walls (402). As the sensor (4) moves from the second position (II) to the first position (I), the sheath (6) is folded and/or compressed and received into the cut out (3) in this form.

In an embodiment of the invention, the helicopter (1) comprises the front surface (401) substantially aligned with the wall of the cut out (3) when the sensor (4) is in the first position (I). The front surface (401) is located almost identical to the wall of the cut out (3). In this way, the sensor (4) is substantially located in the cut out (3) in the first position (I). The front surface (401) is aligned with the outer surface of the body (2), outside the body (2).

In an embodiment of the invention, the helicopter (1) comprises the sheath (6) which is compressed when the sensor (4) is in the first position (I), such that there is no gap between the walls of the cut out (3) and the sensor (4), thus allowing the sensor (4) to be kept still in the opening (3). The sheath (6) allows the sensor (4) to be kept still in the cut out (3), thus preventing aerodynamic effects and absorbing vibrations.

In an embodiment of the invention, the helicopter (1) comprises the front surface (401), which allows the sensor (4) to obtain data both in the first position (I) and in the second position (II); and the control unit (5) which controls the data received from the sensor (4). The front surface (401) interacts directly with the aerodynamic surface and is not covered by the flexible sheath (6). The sheath (6) is attached all around on the lateral walls (402). In adverse conditions or in cases where rapid data acquisition is required, information can be received by the front surface (401) in the first position (I) in which the sensor (4) is located in the body (2). The control unit (5) controls the data received by the sensor (4) at both positions.

In an embodiment of the invention, the helicopter (1) comprises a support element (7) located almost partially around the lateral walls (402), attached to the sensor (4), and surrounded by the sheath (6); at least one rail (8) in the cut out (3), which allows the sensor (4) to slide thereon; at least one actuator (9) which is located in connection with the support element (7) and can slide linearly on the rail (8); the control unit (5) which triggers the actuator (9) upon a command received by the pilot, thus mechanically connected to the support element (7), wherein the control unit (5) allows the sensor (4) to be moved from the first position (I) to the second position (II) or from the second position (II) to the first position (I). The support element (7) is located around the lateral walls (402) so as to be surrounded by the sheath (6) and is mechanically connected to the sensor (4). There is at least one rail (8) in the cut out (3), which allows the sensor (4) to move by sliding. The actuator (9) is provided, which is preferably in mechanical connection with the support element (7) and can move linearly on the rail (8) by sliding. The control unit (5) activates the actuator (9) upon the command received by the pilot. When the actuator (9) is activated, the support element (7) is triggered. The sensor (4) connected to the support element is brought from the first position (I) to the second position (II) or from the second position (II) to the first position (I).

In an embodiment of the invention, the helicopter (1) comprises at least one stopper (10) on the rail (8), which stops and fixes the actuator (9) in alignment with the wall of the cut out (3) in a position predetermined by the user, as the sensor (4) moves from the first position (I) to the second position (II) or from the second position (II) to the first position (I). The stopper (10) stops and fixes the sensor (4) at the boundary points of the first position (I) and the second position (II).

In an embodiment of the invention, the helicopter (1) comprises the actuator (9), which is one of the hydraulic, pneumatic, or electric motor type actuators.

In an embodiment of the invention, the helicopter (1) comprises the sheath (6) made of a water-resistant leather material. The sheath (6) is preferably made of a flame resistant (Flame Resistant Leather, Cassini 1789, Black) or water-resistant leather material.

In an embodiment of the invention, the helicopter (1) comprises the sensor (4) which is one of the laser warning system, missile warning system, or RWR spiral antenna. The sensor (4) can be any sensor (4) attached to the outer surface of the body (2) of the helicopter (1).

In an embodiment of the invention, the helicopter (1) comprises the support element (7) made of an aluminum alloy material by an NC production method. The support element (7) is preferably made of an aluminum alloy material, thereby having a high strength. The support element (7) provides rigidity to the sensor (4). The support element (7), which is connected to the sensor (4) with mechanical connection elements, is triggered by the actuator (9) and moves the sensor (4).

1. A helicopter comprising a body; a cut out located on the body; a sensor located in the cut out so as to move outwards from the body, and enabling the data requested by the user to be obtained; at least one control unit that controls operation of the sensor; a first position (I) in which the sensor is substantially located in the cut out; a second position (II) to which the sensor is brought by moving, and in which the sensor extends through the cut out outward from the body, wherein a front surface which is a part of the sensor facing outward from the body, and which allows the sensor to receive data; at least one lateral wall located on the sensor, extending from the front surface into the body, and allowing the front surface to be held; a sheath made of a flexible material, with one side thereof connected to the wall of the cut out and the other side to the sensor so as to completely surround the lateral walls, wherein the sheath can be folded as the sensor moves from the second position (II) to the first position (I), wherein the sheath provides sealing between the sensor and the cut out in the first position (I) and the second position (II).

2. A helicopter according to claim 1, wherein the sheath with one end connected to the inner wall of the cut out, and the other end connected between the front surface and the lateral walls.

3. A helicopter according to claim 1, wherein the front surface substantially aligned with the wall of the cut out when the sensor is in the first position (I).

4. A helicopter according to claim 1, wherein the sheath which is compressed when the sensor is in the first position (I), such that there is no gap between the walls of the cut out and the sensor, thus allowing the sensor to be kept still in the cut out.

5. A helicopter according to claim 1, wherein the front surface, which allows the sensor to obtain data both in the first position (I) and in the second position (II); and the control unit which controls the data received from the sensor.

6. A helicopter according to claim 1, wherein a support element located almost partially around the lateral walls, attached to the sensor, and surrounded by the sheath; at least one rail in the cut out, which allows the sensor to slide thereon; at least one actuator which is located in connection with the support element and can slide linearly on the rail; the control unit which triggers the actuator upon a command received by the pilot, thus mechanically connected to the support element, wherein the control unit allows the sensor to be moved from the first position (I) to the second position (II) or from the second position (II) to the first position (I).

7. A helicopter according to claim 6, wherein at least one stopper on the rail, which stops and fixes the actuator in alignment with the wall of the cut out in a position predetermined by the user, as the sensor moves from the first position (I) to the second position (II) or from the second position (II) to the first position (I).

8. A helicopter according to claim 6, wherein the actuator, which is one of the hydraulic, pneumatic, or electric motor type actuators.

9. A helicopter according to claim 1, wherein the sheath made of a water-resistant leather material.

10. A helicopter according to claim 1, wherein the sensor which is one of the laser warning system, missile warning system, or RWR spiral antenna.

11. A helicopter according to claim 6, wherein the support element made of an aluminum alloy material by an NC production method.
